(19) United States
(12) Patent Application Publication
(10) Pub. No.: US 2014/0071886 A1
(43) Pub. Date: Mar. 13, 2014

(54) Satellite Communication Device for Routing Terrestrial Signals Through a Satellite Network

(71) Applicants: Paul A. Monte, San Jose, CA (US); Ronnie Daryl Tanner, Covington, LA (US); Eric Blanchard, Covington, LA (US); Mark Edward Sutton, Covington, LA (US); Alfonso Bravo, Sterling, VA (US); Walter DeBus, Covington, LA (US)

(72) Inventors: Paul A. Monte, San Jose, CA (US); Ronnie Daryl Tanner, Covington, LA (US); Eric Blanchard, Covington, LA (US); Mark Edward Sutton, Covington, LA (US); Alfonso Bravo, Sterling, VA (US); Walter DeBus, Covington, LA (US)

(73) Assignee: Globalstar, Inc., Covington, LA (US)

(21) Appl. No.: 13/983,690

(22) PCT Filed: Feb. 7, 2012
(86) PCT No.: PCT/US12/24177

§ 371 Date: Nov. 22, 2013

Related U.S. Application Data
(60) Provisional application No. 61/440,706, filed on Feb. 8, 2011.

(51) Int. Cl. H04B 7/185

(52) U.S. Cl. CPC H04B 7/18517
USPC 370/316; 455/430

(57) ABSTRACT

A interface device and a method of allowing communication is provided to allow a wireless mobile communications device to interface with a satellite communication system. The interface includes a satellite modem (including antenna), a communications link to communicate with the wireless communications device (such as a Wifi link using VoIP) and an applications processor (with associated memory) to handle control and handshaking functions between the communications link and satellite modem and the related interfaced equipment (mobile communications device and satellite system) and to assist and reformat as needed transmission of data between the interfaced equipment.

### PRIORITY CLAIM

This application claims priority to U.S. Provisional application No. 61/44,076, the contents of which are incorporated by reference in its entirety.

### BACKGROUND OF THE INVENTION

Cell phones communicate via a wireless connection to interface the mobile communications network or the public switched telephone network. Satellite phones communicate over a separate satellite network to eventually route a call to an end user attached, for instance, through the public switched telephone network or the mobile communications network. It would be desirable to provide the capabilities of a satellite phone to a cellular phone, or vice versa.

### TECHNICAL FIELD

This invention relates to systems and methods to relay information from devices using terrestrial short-range wireless technologies (or certain wired technologies) over satellite communication systems, optimizing the bandwidth required for voice calls over satellite networks. It addresses the advantage to use different types of terminal equipments to provide data and voice services in areas where there is no major communications infrastructure over a satellite constellation without any major re-development of the wireless end user device.

### SUMMARY OF THE INVENTION

A device that enables a cellular phone to communicate over a satellite communications network. A method and device to provide voice and data services to mobile device users by accessing short distance access technologies (for instance, IEEE 802.11 WiFi, a/g/n, or using short wavelength radio transmissions in the ISM band from 2400-2480 MHz from fixed and mobile devices, creating personal area networks (PANs) (such as Bluetooth), GSM transmission, etc) over a satellite communications system is provided. The wireless system connects to and controls processing of sessions from different types of personal communication devices (handsets, smartphones, PDAs and computers) through any short range wireless technologies and backhauls them over a satellite network. In areas where such infrastructure is inexistent only satellite communication systems are available to carry the information to the Internet or to the Public Switched Telephone Network (PSTN).

### BRIEF DESCRIPTION OF DRAWINGS

FIG. 1 illustrates one embodiment of a communications network implemented by the current invention.

FIG. 2 illustrates the components of a conventional satellite phone.

FIGS. 3 to 8 illustrate various steps in call handling.

FIG. 9 is a flowchart of steps in handling an outbound call.

FIG. 10 is a flowchart of steps in handling an inbound call.

FIG. 11 illustrates an alternative embodiment implementing Internet data connectivity.

FIG. 12 illustrates an alternative embodiment of direct VoIP transmission.

FIG. 13 illustrates an alternative embodiment for connectivity with a femtocell network.

FIG. 14 illustrates an alternative embodiment where voice data is digitally transcoded.

FIG. 15 illustrates a satellite communication device slightly modified from FIG. 1.

### DESCRIPTION OF SELECTED EMBODIMENTS

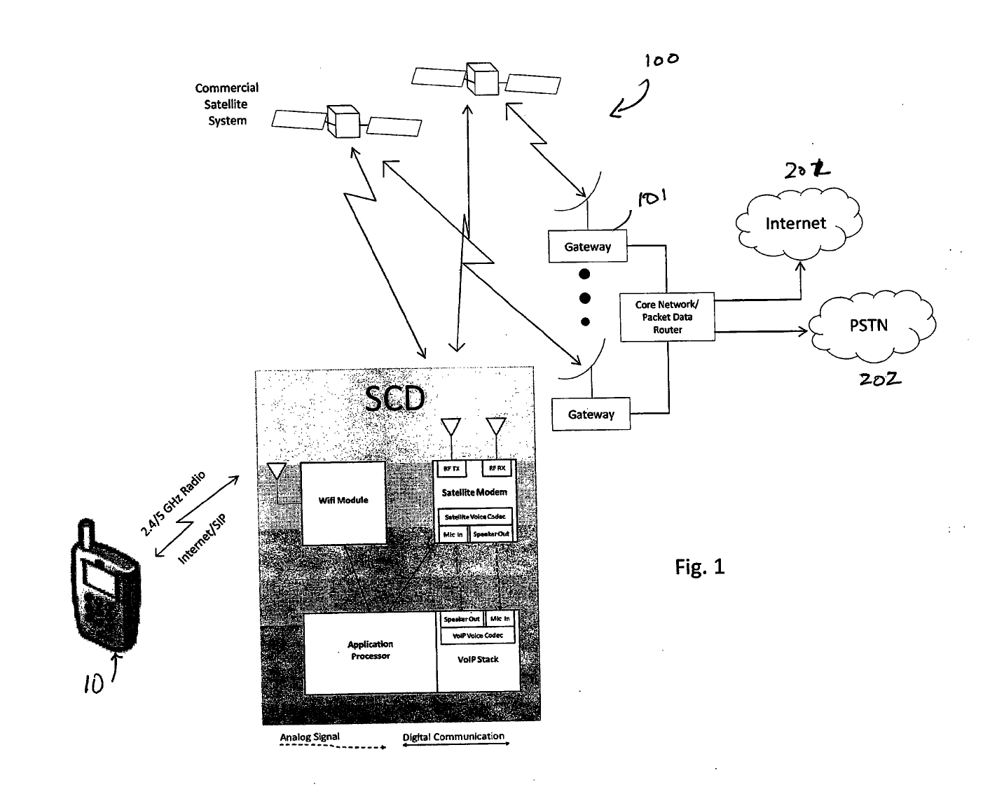

FIG. 1 illustrates one example of a communications network implemented by the present invention. The network generally includes one or more hand-held portable communication devices 10, examples of which could be smart-phones, conventional cell phones, PDAs, portable PCs, computing tablets, and the like. Many of these devices, e.g., smart-phones, are capable of converting an analog voice signal into a VoIP data stream and sometimes will be referred to as “VoIP transmitting devices.” VoIP is not required, as will be later described.

The FIG. 1 communications network further includes a conventional satellite network 100 which communicates through satellite gateways 101 to a core network (including packet data routing systems) which ultimately transfers information to the Internet 201 or a public switched telephone network 202 (or PSTN). As explained in detail below, the satellite communications device of the current invention functions to transmit data from the hand-held communication devices 10 across the satellite network 100 to the core network 201 or 202, and also in the reverse direction from the core network to the hand-held communication devices through the satellite network 100. Although FIG. 1 only shows one hand-held device 10, it will be understood that multiple hand-held devices could be part of a network having at least one satellite communication device.

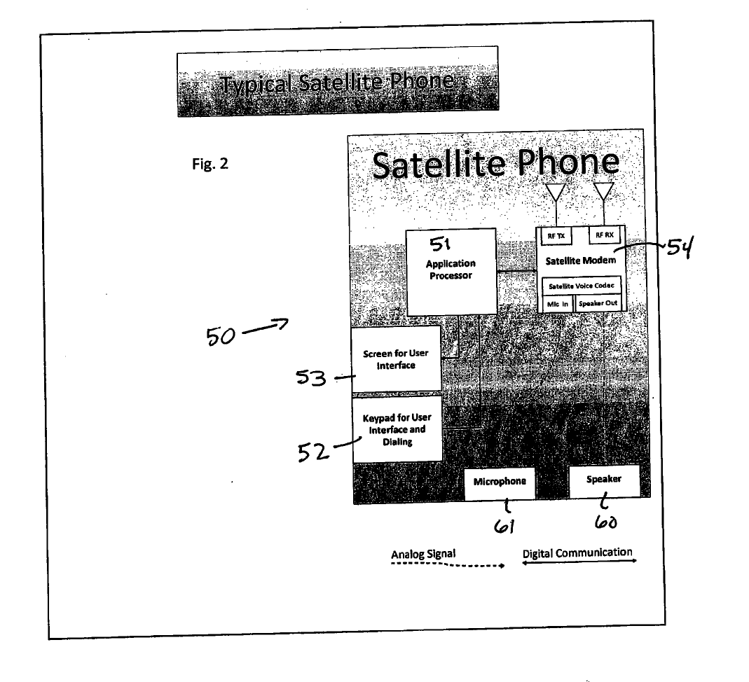

As background information, FIG. 2 illustrates the principle components of a conventional satellite phone 50. In conventional satellite phones, the application processor 51 takes in information from the keypad interface 52 and drives the display screen 53 for the user. When the user is ready to make a call, the application processor 51 generates the required information and serial commands to cause the satellite modem 54 to connect to the satellite network 100 and route the call appropriately. When the call is connected, the speaker 60 and microphone 61 bring and send analog voice information for the user. The satellite modem 65 within the phone contains a voice codec that converts this information from analog to digital and vice versa. The call is terminated by the satellite phone user by pushing a button on the keypad 52 and the application processor 51 sending suitable information and serial commands to the modem 54 to close the connection. If the call is terminated by the other call participant, the satellite modem 54 receives a signal informing it of this event via the satellite and sends serial commands to the application processor 51 that the connection is closed, to allow the processor 51 to complete termination of the call (for instance, notifying the user that the call has ended).

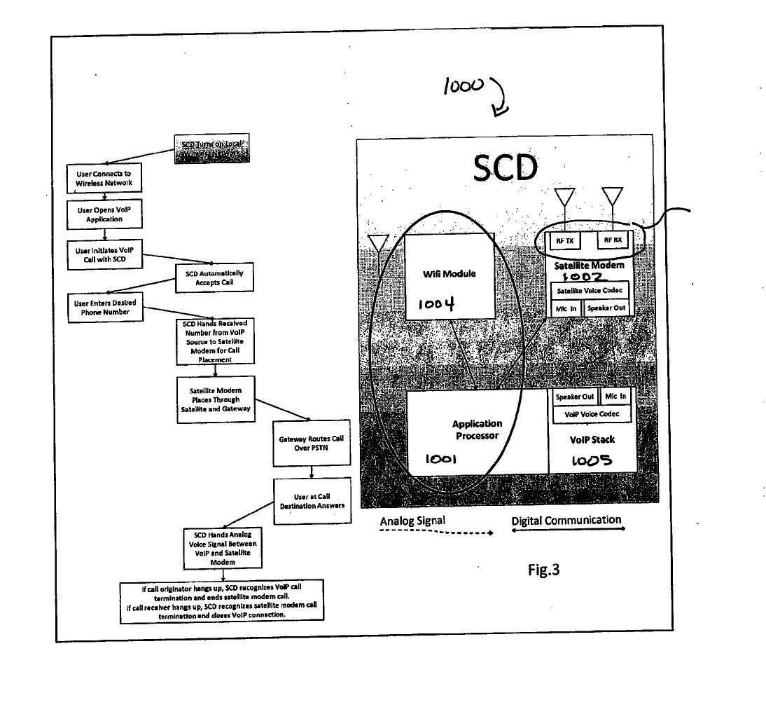

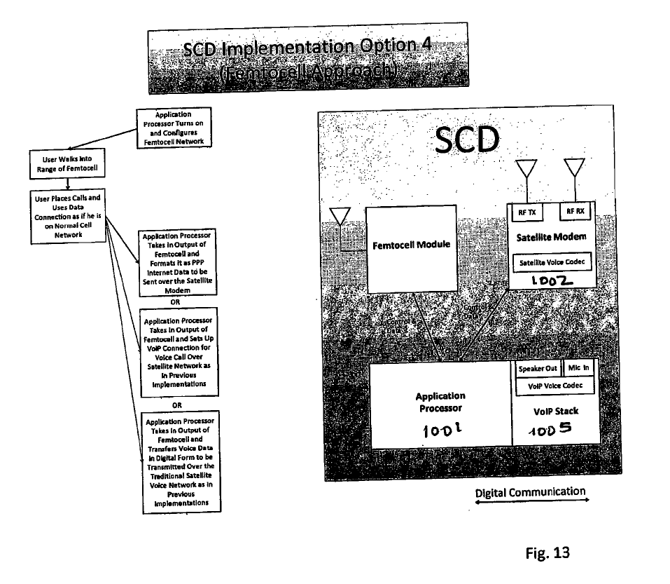

FIG. 3 illustrates one embodiment of the satellite communication device 1000 (often referred to in this description as an “SCD” or as a “Button”) and the steps taken to initiate a call. This embodiment of the SCD includes (i) an application processor 1001, (ii) a satellite modem 1002, iii) a communications linkage to communicate between the SCD and the mobile device, such as an radio band wireless transceiver 1004, (for instance, a industrial, scientific and medical (ISM)transceiver (in FIG. 3 a Wifi module), and (iv) a VoIP 1005 stack which provides process instructions to the application processor (the VoIP stack can be integrated in the application processor, either as hardware, firmware of software). In alternate embodiments, the VoIP stack could be replaced with a VoIP module (i.e., chip or chip set). Likewise, the Wifi module 1004 could be effectively replaced with a software stack directing the application processor to perform the functions of the Wifi module. As described below, the communications link between the SCD and mobile device is described as Wifi using VoIP, as implemented in the Wifi module 1004. However, the inventions is not so limited. Instead, a PAN communications line can be established between the SCD and mobile device using, for instance, Bluetooth, Alternatively, net communications link could be used, such as by employing a femtocell, such as shown in FIG. 13. indeed, wireless communication may be replace with aired communications, for instance, if a tablet is the mobile device, direct wired communications can be established to the SCD, such as using Ethernet, UCB, firewire, or other communications link.

Most of the following embodiments are described a uning a wireless communications link, primarily using WiFi VoIP.

In one embodiment the application processor 1001 of the SCD sends commands to the Wifi module 1004 for setup and configuration for wireless communication between the SCD to communicate and the mobile device. In other embodiments, the SCD and mobile device may both access an existing wireless network (for instance, a WLAN) (where SCD and mobile device have identifiers that enable the routing of communication between them), or the WiFi module 1004 creates a wireless access point, or waits for creation of ad hoc. The options can be user selected, or configuration defaults may be established in the SCD or mobile device. For the remaining discussion, it will be assumed that the wireless network is established by the SCD.

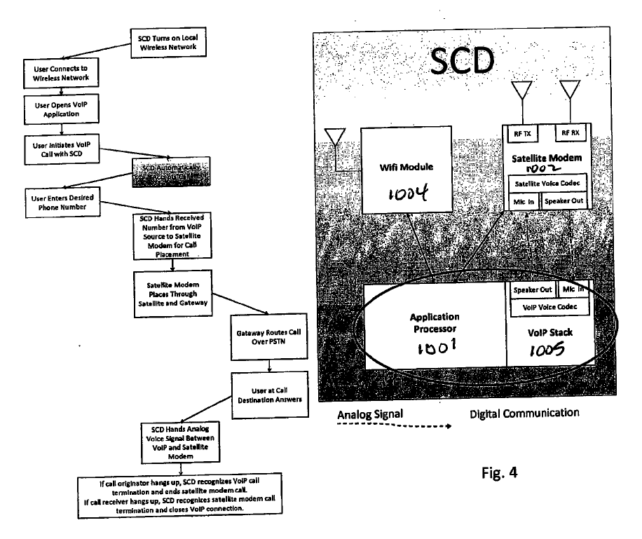

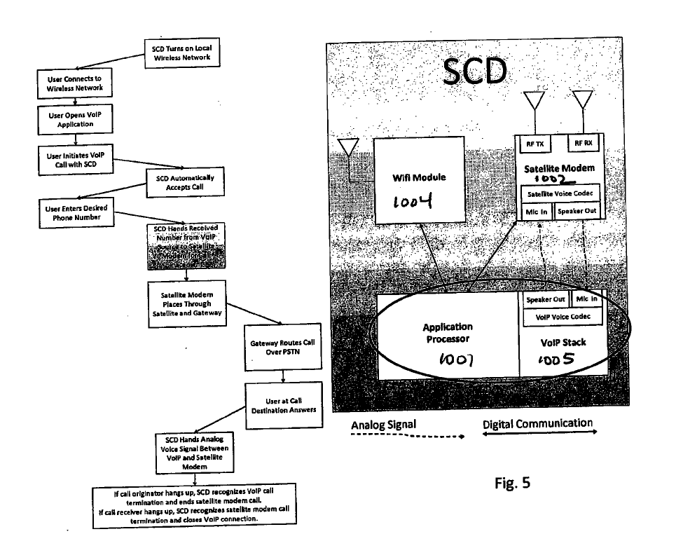

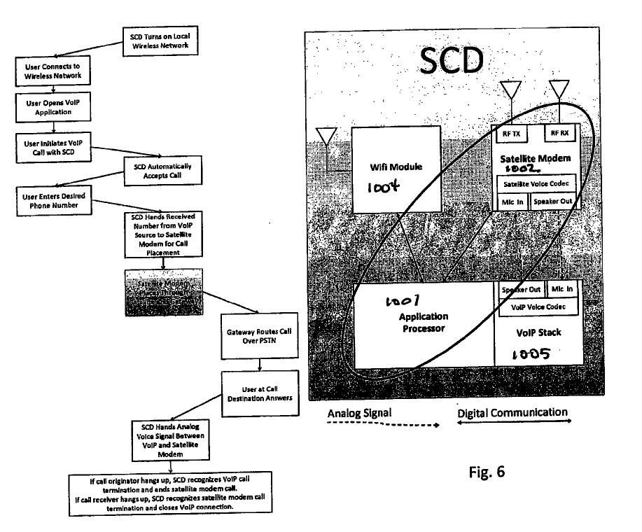

FIG. 4 indicates how the VoIP stack 1005 can direct a request from the mobile device to place a satellite call. The mobile phone communicates with the SCD through the wireless network to the WiFi module on the SCD. For instance, the mobile may communicate via a VoIP application on the mobile phone, or transmit an “identifier” that is sent to the WiFi module and recognized by the applications processor as a request for service, or some other handshaking between the mobile device and SCB via wireless communication that indicates a satellite call is to be placed. The VoIP stack 1005 alerts the application processor 1001 of an incoming call request, usually via serial communication. The application processor 1001 then sends commands (per the VoIP stack) to accept the call from the mobile device. Viewing FIG. 5, the application processor 1001, for instance, receives a DTMF signal (or other signal) containing the call destination identifier, transmitted by the user over the wireless communications link between the mobile phone and the SCB (via the WiFi module 1004) The identifier may be interpreted or reformatted by the application processor 1001, as needed. In FIG. 6, the application processor 1001 sends commands and/or handshaking signals (usually by serial communication) to the satellite modem 1002 for establishing the phone call to the desired call destination identifier (e.g. phone number).

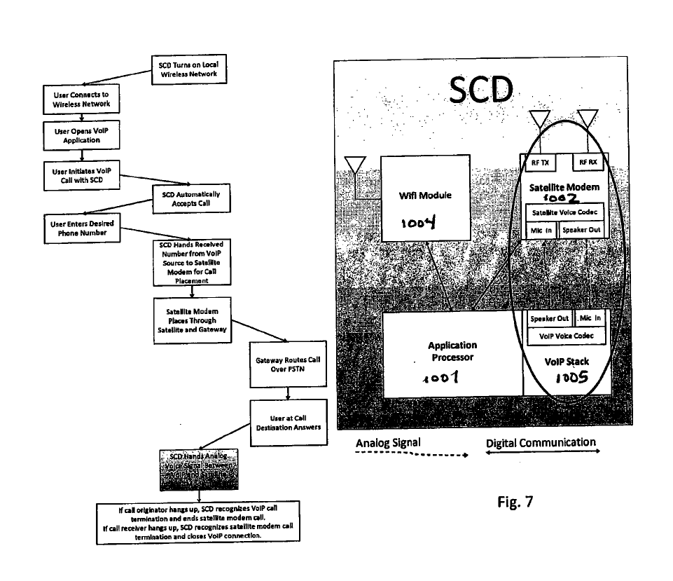

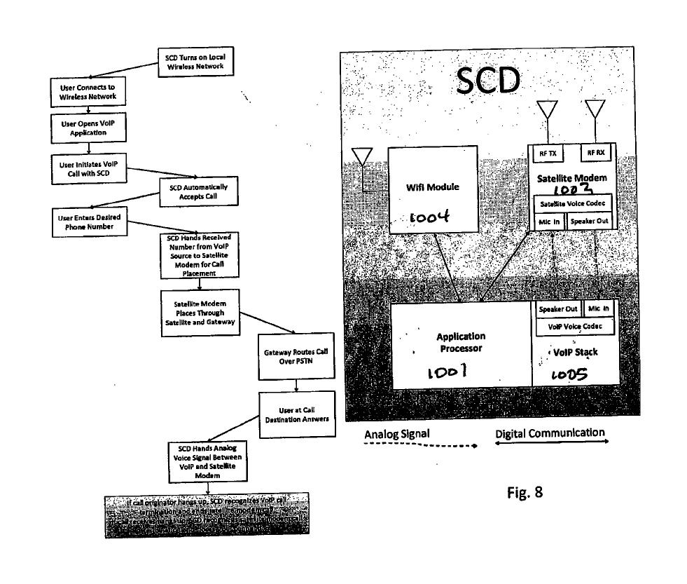

FIG. 7 suggests one embodiment where the VoIP stack (or the application processor) takes in digital (VoIP) voice information from the WiFi module 1004, converts it back to analog, and then pushes it through its “speaker port” (analog output) to the analog input port of the satellite modem 1002 (labeled a microphone input port). The satellite modem 1002 takes analog voice signal from its microphone input, uses its voice codec to convert the analog lvoice signal, back to digital for transmission over the satellite network. The same operation will take place in the reverse direction when the SCD is receiving voice information from the satellite network. FIG. 8 indicates how the application processor sends appropriate commands to either the satellite modem or processes through the VoIP stack based on where the call is closed. These A-D steps can be eliminated by having the application processor 1001 converted the received digital data from one component (the WiFi module or the Satellite modem) and transforming that signal to the proper digital format for the other component. Indeed, the digital data may be properly formatted and no conversion is necessary. The remaining discussion assumes that the A_D conversions are employed.

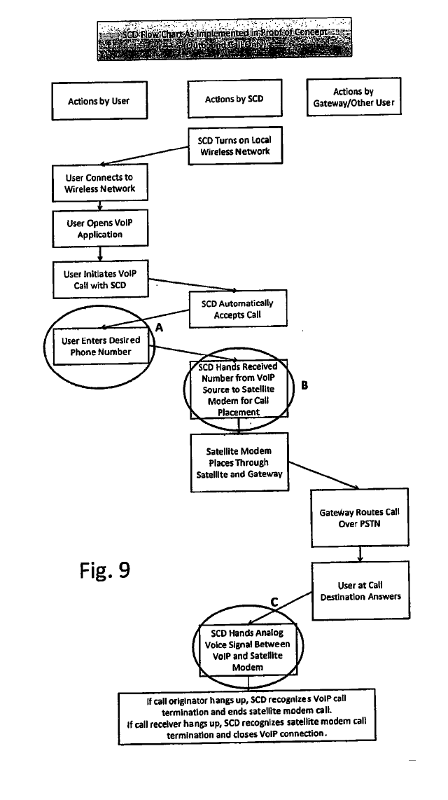

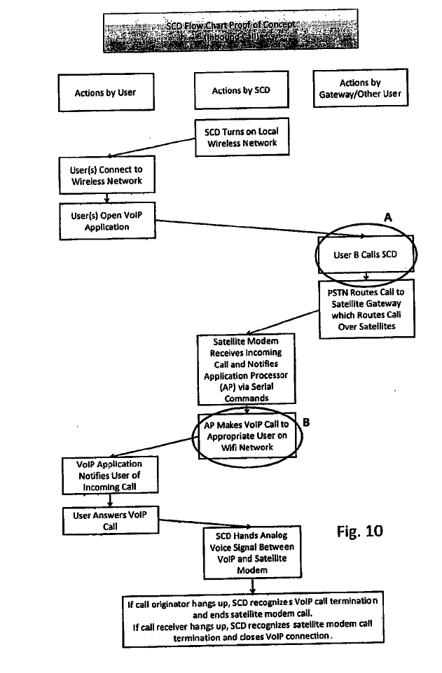

FIG. 9 generally illustrates the steps carried out when the SCD is handling an outbound (i.e., from the smart-phone to the satellite network) call, while FIG. 10 generally illustrates the steps carried out when the SCD is handling an inbound call (i.e., from the satellite network to the mobile device). As shown in FIG. 9, the smart phone or other mobile device is in communication with the SCD WiFi modem via wireless network. In step A, the user will enter the desired number on the smart-phone. For example, the user can use DTMF (Touch Tone) dialing to enter their desired call destination, or speak the phone number and the application processor can be used to perform voice recognition on the signal. In the case of a smart-phone or other programmable device, a custom VoIP application could be installed on the phone, and the user could search through his/her contact list and chose the desired call destination. Preferably, an application on the smart phone initiates a link and handshaking with the SCB, and transfers the number to be dialed to the SCD. This process can be transparent to the user, (e.g. the establishing of communications between the SCD and the smart phone) so the user never notices that, in effect, two “calls” or communication links are actually being placed, one communication link to between the mobile device and SCD (as shown, via VoIP) and one, via the SCD, to the satellite system and thence to the PSTN and final destination

In step B of FIG. 9, the SCD hands the received number from the VoIP source (e.g., smart-phone) to the satellite modem for call placement. Regardless of the method used to receive the destination phone number from the mobile device, eventually the application processor 1001 must take that information and wrap it in the appropriate protocol needed in order to request the satellite modem 1002 to place the call.

In step C of FIG. 9, after the call has been established between the mobile and end user via satellite, the SCD routes the voice signal received by the VoIP stack to the satellite modem 1002. To implement these steps, in one embodiment, the VoIP stack receives digital call information using VoIP protocol via the WiFi connection from the smart-phone. The VoIP stack uses its voice codecs to generate an analog voice signal from this information. That signal is put out over the speaker output port. The analog signal is then routed into the microphone input of the satellite modem where the satellite modem's own voice codecs re-digitize the signal with a satellite specific, more bandwidth efficient, protocol. The satellite gateway once again breaks this signal down and routes it to the PSTN to the called number. As shown in FIG. 9, the voice signal is indicated as analog, which is sent form the A-D converted in the application processor to the microphone input of the satellite modem. As discussed above, these A-D conversions are only for one embodiment of the inventions

In the reverse direction, a voice signal comes in via the PSTN from the a third party calling the smart-phone user (“third party caller” or “User B” in the FIG. 10). The satellite gateway sends the signal to the satellite network in digitized form using the satellite codec. Once received by the satellite modem 1002 (which has a identifier in the satellite system), the voice data (in one embodiment) is converted to analog and put out over the satellite speaker output, and then to the VoIP stack's 1005 microphone input where it is digitized using its codec and transmitted to the smart-phone over the via the WiFI module 1004. The applications processor handles handshaking and control between the components of the SCD. The VoIP application on the smart-phone converts the signal to the appropriate format so that it can drive the speaker on the smart-phone.

FIG. 10 emphasizes the steps in handling an incoming call from a third party caller. Step A involves the third party caller initiating the phone call. In one basic embodiment, the third party caller will actually dial the SCD's satellite phone number when the third party caller wishes to contact the smart-phone user (if the SCD is dedicated to a single mobile device, no other identifier is needed; however, if the SCD interfaces multiple mobile devices, the SCD number must be accompanied with the desired mobile identifier, such as the mobile phone number). In another embodiment, when the smart-phone user connects to the WiFi network and opens a custom VoIP application on the smart-phone, his phone number can be sent of the WiFI network to register his satellite number as a call forward number, or send over the SCD wireless link to be sent over the satellite network, also registered the satellite number with the cell phone service provider as a call forwarded number. This alternative eliminates the need for the third party caller to know two phone numbers or recognize when the smart-phone user is out of cell range.

In step B of FIG. 10, the application processor 1001 makes a VoIP “call” to the appropriate smart-phone user on the associated WiFi network. For instance, if the cell phone service provider has associated the SCD's number and the smart-phone user's number, then the service provider could supply the satellite gateway with the original destination (the mobile number to be reached) before the call is forwarded. The gateway could relay this information to the SCD for routing. For instance, the information could be relayed to the SCD via an internet connection to the satellite modem 1002. Once received by the satellite modem 1002, the SCD can use this information to route the incoming satellite call to the appropriate smartphone via a VoIP/Wifi connection.

In another embodiment, the third party caller “places” two calls—first, the third party caller would call the SCD via the SCD satellite number, and the SCD could transmit back a request to identify the desired mobile subscriber. For instance, the third party caller could be greeted with a menu system once the satellite modem receives the call, then via DTMF or voice commands, the third party caller could enter the desired mobile device identifier (e.g., phone number or “extension”) on the SCD's Wifi network to which the third party caller wishes to be connected (for instance, when the SCD acts as a PBX system for multiple to access a satellite system). This could be either a list of currently connected users, or just the third party caller entering the phone number of their desired call destination.

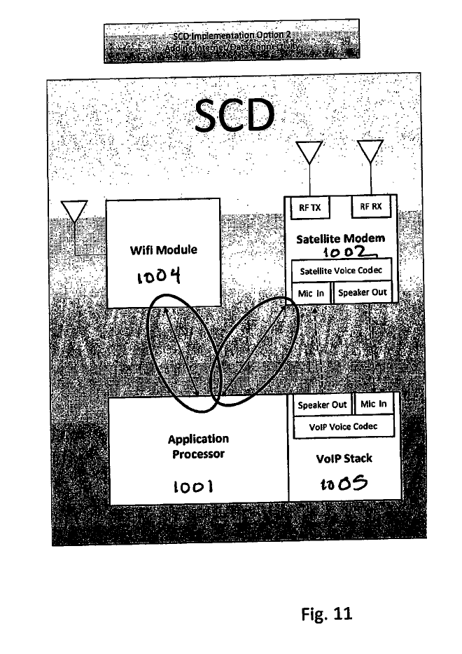

FIG. 11 illustrates an embodiment which incorporates Internet or general connectivity as well as voice capability in the SCD. In this embodiment, when the smart-phone user connects to the Wifi network (possibly using an app that indicated internet connectivety is requested0, the application processor 1001 configures the satellite modem 1002 to establish a PPP Internet connection over the satellite network. As one example, this could be accomplished by configuring a GSP-1700 (model no.) satellite modem available from Globalstar, Inc. for a PPP data call and having the application processor perform the necessary data conversions to pass smart-phone wirelessly transmitted Internet data from the Wifi module over the PPP connection (and likewise to transmit Internet data to the smart-phone via the Wifi module from a PPP source).

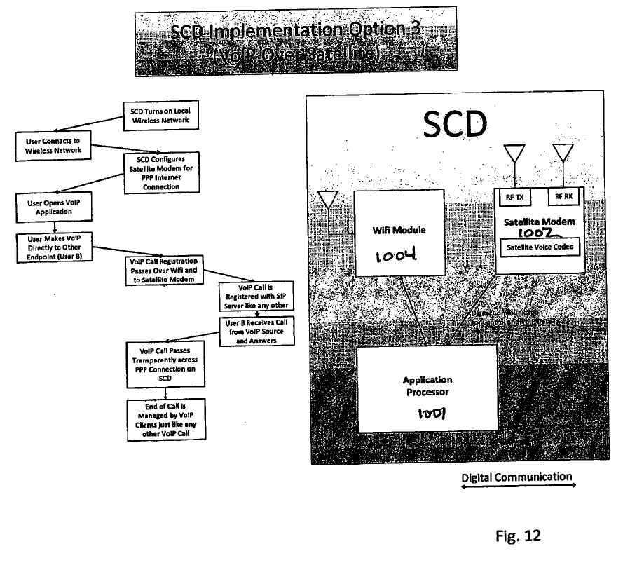

FIG. 12 illustrates an alternate embodiment which, if provided with a sufficiently high connection speed, will allow the satellite modem to operate with conventional (e.g., DSL) modem functionality. The smart-phone user connects to a Wifi hotspot, places a VoIP call to the SCD in the manner described. and the call is routed using a VoIP server (for example, a SIP server instead of using a VoIP stack) on the SCB, and the SCD configures the satellite modem 1002 for a point-to-point protocal (PPP) Internet connection. The SCD receives the data over the Wifi connection and passes the data stream directly to the satellite modem 1002. At the core network (the satellite gateway), the VoIP call is registered with a SIP server in the conventional manner. The third party answer to the call is likewise transmitted across the satellite network via the PPP Internet connection.

FIG. 13 is another alternative embodiment. Conceptually this embodiment involves substituting the Wifi link with a femtocell. A femtocell is a local range cellular network (similar to a conventional tower network, but for local area use). Femtocell networks are used to extend the cell network in office buildings or to save on airtime charges because femtocell networks typically allow a user to place a standard cell phone call over the network, but instead of getting to the PSTN via the cell towers, the femtocell network intercepts the signal and routes it over the Internet as VoIP. In the FIG. 13 embodiment, rather than the call being intercepted and routed as VoIP through a standard internet connection, the SCD would intercept the call and route it via a satellite internet connection (i.e., via the satellite modem) to allow for remote use. The user would not be charged for conventional cell phone minutes, nor would the user need to execute the connection steps required in previously discussed embodiments.

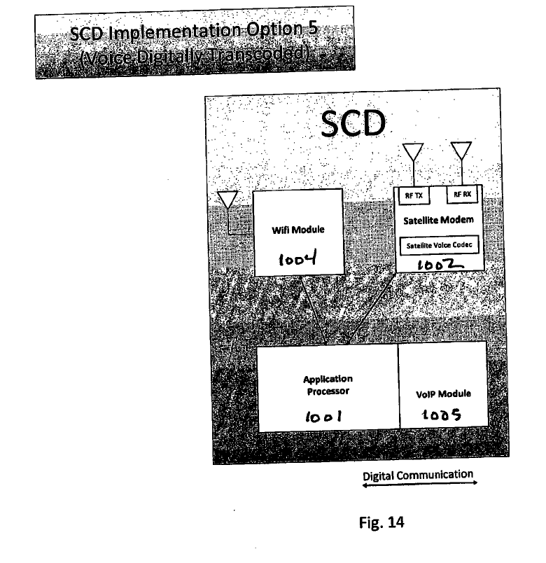

FIG. 14 represents an alternative embodiment wherein the conversion of VoIP voice data does not take place by bringing the signal down to analog then to digital again inside the satellite modem, but instead takes place through digital conversion inside the application processor. The call management information is still handled the same as in the descriptions of FIGS. 2-10, but the voice signal is passed differently.

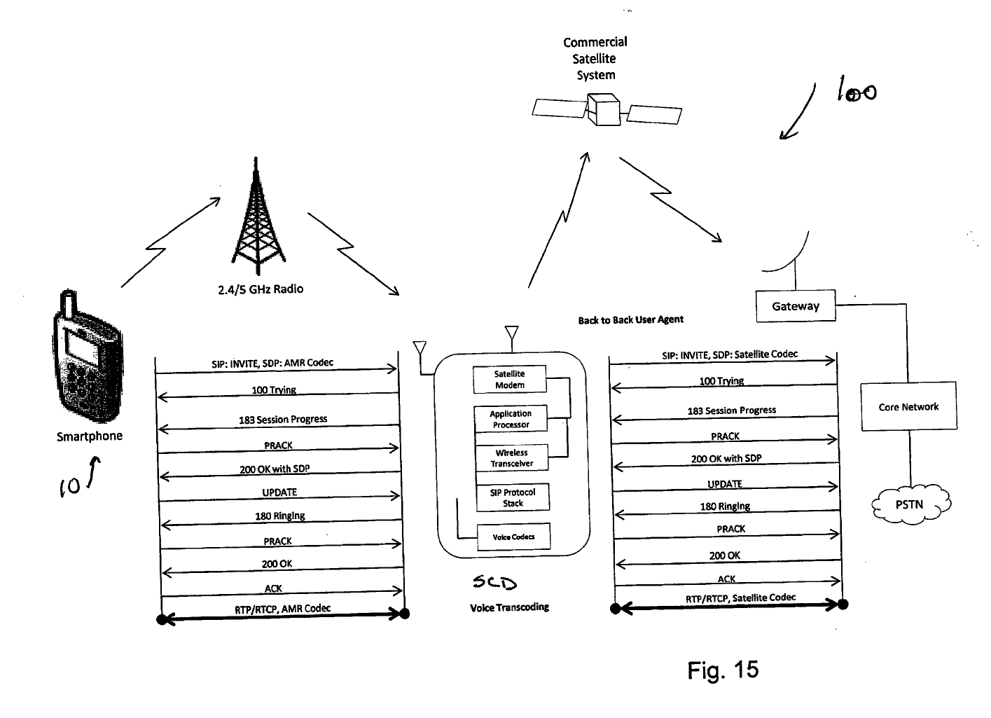

FIG. 15 shows some of the control and/or information signals that may be sent through the SCD for purposes of handling or processing a call. These signals will vary based on the type of call being placed (voice, data, video, etc) and on the type or manufacturer of equipment being interfaced, and is simply an example of transmission of control signals through the SCD.

Although certain embodiments were described in reference to the figures, those skilled in the art will recognize many alternate uses for SCD devices similar to those described herein. Such alternative uses could include:

1) Speaker and microphone arrangement on a SCD giving it voice conferencing ability (like a Polycom);
2) A camera and monitor on a SCD giving it video teleconferencing ability;
3) Interactive gaming with one or more participants at a SCD, interacting with remote participants either at a SCD or on public networks (without delays of geo satellites);
4) Secure communications (“off the grid”) of voice or data from SCD to SCD, or SCD to public networks, using encryption;
5) Interrogatable transponders for tracking of hazardous materials, with wired or wireless sensors, interrogatable transponders for tracking of assets, with wired or wireless sensors;
6) SCDs incorporated into roadside emergency phones, with or without video;
7) SCDs incorporated into roadside video camera monitoring of traffic;
8) SCDs integrated with toll station data relays;
9) A portable bar code scanners wirelessly or wired to an SCD for inventory management and asset tracking;
10) Point-of-sale terminals using a SCD for pricing and charging;
11) SCDs integrated with remote polling stations vote collection and processing;
12) SCDs integrated with remote security access for opening gates or doors with password entry or biometrics;
13) Multiple wireless device animal tracking using one SCD for data collection and transmission;
14) Multiple wireless or wired asset tracking using one SCD for data collection and transmission;
15) SCDs employed for motion-based, sound-based, or video scene recognition-based remote monitoring;
16) SCDs employed for remote computer file back-up;
17) Concatenation of multiple SCDs to increase bandwidth, data processing on both ends to make one data stream out of several circuits;
18) Wi-Fi roaming from SCD to SCD while preserving session;
19) SCDs connected to PBX for call routing;
20) SCDs employed in border security monitoring;
21) Remote public address systems (speaker at SCD);
22) SCDs employed in weapons activation or detonation;
23) SCDs employed in vehicle telemetry monitoring with remote control of vehicle parameters (e.g. trucking directions, speed control, fuel usage);
24) SCDs employed in advanced AIS type maritime applications; and
25) SCD's employed as battlefield replacement of HF radios.

1-59. (canceled)

60. An interface device to a mobile communications device to provide satellite communication ability, where the mobile communication device lacks the ability to transmit and receive communications directly to a satellite in a satellite communication network said interface device being distinct from and not physically integrated into a mobile communication device, said interface device comprising a satellite modem, said interface device further having an identifier on a satellite communications network for third parties to direct communications to said interface device through said satellite communications network, an antenna for communication with a satellite on said satellite communications network, a communication link configured to establish communications between said mobile communications device and said interface device, and a processor, where the processor is configured to interface said communication link and said satellite modem to enable two way communications between said mobile communications device and said satellite communications network through said satellite modem and said communications link

61. The interface device according to claim 60 wherein said mobile communications device is a mobile cellular communications device.

62. An interface device according to claim 61 wherein said communications between said mobile cellular device and said interface device comprises wireless non-cellular communications.

63. An interface device according to claims 61 wherein said communications between said mobile device and said interface device comprises wired communications.

64. An interface device according to claim 62 wherein said wireless communication comprises WiFi communications.

65. An interface device according to claim 60 where said mobile communications device comprises cellular phone, a PC, or a tablet.

66. An interface device according to claims 64 wherein said communications link further comprises a WLAN communications link or a personal access network communications link.

67. An interface device according to claim 64 wherein said WiFi communications further comprises VoIP communications.

68. A method to establish satellite communications with a mobile cellular communications device that lacks the ability to transmit and receive communications directly to a satellite in a satellite communications network, comprising the steps of receiving, at an interface device, a first incoming request for communications over a first communications channel, where said interface device lacks cellular communications ability; said interface device being distinct from and not physically integrated into a mobile cellular communication device, said first communications channel either between the mobile device and the interface device, or directly between a communications satellite and the interface device, said interface device initiating communications to the other of the communications satellite or the mobile cellular device over a second communications channel, and when communications are established over said second communications channel, enabling two way communications through said interface device between said mobile cellular communications device and said communications satellite on said first and second communications channels.

69. A method according to claim 68 wherein said first communications channel is directly between said mobile cellular communication device and said interface device and comprises wireless non-cellular communications.

70. A method according to claim 68 wherein said first communications channel is directly between said interface device and said communications satellite.

71. A method according to claims 68 wherein said communications between said mobile cellular communications device and said interface device comprises wired communications.

72. A method according to claim 69 wherein said wireless communications comprises WiFi communications or VoIP WiFi communications.

73. A method according to claim 68 where said mobile cellular device comprises a cellular phone, a PC or a tablet.

74. A method according to 68 wherein said first communications channel further comprises a WLAN communications channel or a personal access network communications channel.

75. The method of any of claims 68 where said interface device receives a second incoming request for communications over a third communications channel, said third communications channel either between a second mobile device and the interface device, or between a communications satellite and the interface device, said interface device initiating communications to the other of the communications satellite or the second mobile cellular device over a fourth communications channel, and when communications are established over said fourth communications channel link, enabling two way communications through said interface device between said second mobile cellular communications device and said satellite through said third and fourth communications channels.

76. The method of claim 68 wherein said first communication channel is between said interface device and said satellite, and said incoming request includes an identifier associated with said mobile cellular enabled communication device.

77. The method of claim 76 wherein said identifier is a cellular phone number or a satellite phone number.
